(19) United States
(12) Patent Application Publication
(10) Pub. No.: US 2011/0149470 A1
(43) Pub. Date: Jun. 23, 2011

(54) MULTILAYER CERAMIC CAPACITOR AND MANUFACTURING METHOD THEREOF

(75) Inventors: Kang Heon Hur, Suwon (KR); Hyun Tae Kim, Seoul (KR); Doo Young Kim, Yongin (KR); Eun Sang Na, Yongin (KR); Joon Hwan Kwag, Seoul (KR); Mi Young Kim, Suwon (KR); Byung Gyun Kim, Jinhae (KR); Byung Jun Jeon, Seoul (KR)

(73) Assignee: SAMSUNG ELECTRO-MECHANICS CO., LTD.

(21) Appl. No.: 12/974,743

(22) Filed: Dec. 21, 2010

(30) Foreign Application Priority Data
Dec. 22, 2009 (KR) 10-2009-0129305

(51) Int. Cl. H01G 4/12; H01G 7/00

(52) U.S. Cl. 361/321.2; 29/25.42

(57) ABSTRACT

Provided are a multilayer ceramic capacitor and a manufacturing method thereof, which can stably secure capacitance and prevent cracking caused by the diffusion of an electrode material. The multilayer ceramic capacitor includes a capacitor body where an inner electrode including a first electrode material and a dielectric layer are alternately laminated, and an outer electrode disposed on an outer surface of the capacitor body and electrically connected to the inner electrode, the outer electrode including a second electrode material. A diffusion layer having a length exceeding 1 μm in which the first and second electrode materials are mixed is provided at a region where the inner electrode and the outer electrode are connected to each other.

### CROSS-REFERENCE TO RELATED APPLICATIONS

This application claims the priority of Korean Patent Application No. 10-2009-0129305 filed on Dec. 22, 2009, in the Korean Intellectual Property Office, the disclosure of which is incorporated herein by reference.

### BACKGROUND OF THE INVENTION

1. Field of the Invention

The present invention relates to a multilayer ceramic capacitor and a manufacturing method thereof, and more particularly, to a multilayer ceramic capacitor capable of not only stably securing capacitance but also preventing cracking caused by the diffusion of an electrode material, and a manufacturing method thereof.

2. Description of the Related Art

In general, multilayer ceramic capacitors include a plurality of ceramic dielectric sheets and inner electrodes interposed between the ceramic dielectric sheets. Multilayer ceramic capacitors are being widely used as capacitive parts in various electronic devices, due to their small size, high capacity and ease of mounting.

Recently, as electronic products have become compact and multi-functional, chip components have also tended to become compact and highly functional. Following this trend, multilayer ceramic capacitors are required to be smaller but to have a higher capacitance than ever before. Accordingly, multilayer ceramic capacitors where a dielectric layer has a thickness of 2 μm or less and number of laminated layers is 500 or more have recently been manufactured.

An outer electrode is installed at a lateral cross section where an inner electrode is exposed among lateral cross sections of a ceramic capacitor. Generally, a typical conductive paste used for forming an outer electrode contains a copper powder into which a glass frit, a base resin, an organic vehicle, and the like are mixed.

The outer electrode is formed by coating a lateral cross section of a ceramic capacitor with an outer electrode paste, and firing the ceramic capacitor coated with the outer electrode paste to sinter metal powders in the outer electrode paste.

In the case of a multilayer ceramic capacitor with small number of laminated layers, cracking caused by a diffusion phenomenon from an outer electrode to an inner electrode does not occur even though a diffusion layer is sufficiently formed between the outer electrode and the inner electrode. Therefore, a major concern is focused on a technique of reducing capacitance deviation by increasing the contact property maximally, as one of several key techniques in polishing, outer electrode paste preparation, and outer electrode firing.

However, in the case of a multilayer ceramic supercapacitor with a large number of laminated layers, although the contact property between the outer electrode and the inner electrode is increased, there is a serious problem which does not take place in the multilayer ceramic capacitor with small number of laminated layers. Specifically, when the diffusion occurs heavily from the outer electrode toward the inner electrode in the multilayer ceramic capacitor with large number of laminated layers, cracking is generated due to the expansion in the volume of the inner electrode, resulting in a decrease in bending strength, and moreover, a plating solution penetrates into the generated cracks to thereby degrade the reliability of a product.

### SUMMARY OF THE INVENTION

An aspect of the present invention provides a multilayer ceramic capacitor that can not only stably secure capacitance but also prevent cracking caused by the diffusion of an electrode material, and a manufacturing method thereof.

According to an aspect of the present invention, there is provided a multilayer ceramic capacitor including: a capacitor body where an inner electrode including a first electrode material and a dielectric layer are alternately laminated; and an outer electrode disposed on an outer surface of the capacitor body and electrically connected to the inner electrode, the outer electrode including a second electrode material, wherein a diffusion layer having a length exceeding 1 μm in which the first and second electrode materials are mixed is provided at a region where the inner electrode and the outer electrode are connected to each other.

The diffusion layer may have a length less than 13 μm.

The first electrode material may include nickel (Ni) or Ni alloy.

The second electrode material may include copper (Cu) or Cu alloy.

The diffusion layer may include Ni/Cu alloy.

The number of laminated dielectric layers may be in a range of 50 to 1,000.

According to another aspect of the present invention, there is provided a method of manufacturing a multilayer ceramic capacitor, including: forming a capacitor body by laminating an inner electrode including a first electrode material and a dielectric layer alternately; forming an outer electrode electrically connected to the inner electrode on an outer surface of the capacitor body, the outer electrode including a second electrode material; forming a passivation layer including a dielectric forming material on at least one of top and bottom surfaces of the capacitor body; compressing the capacitor body; and firing the capacitor body, wherein a diffusion layer having a length exceeding 1 μm in which the first and second electrode materials are mixed is formed at a region where the inner electrode and the outer electrode are connected to each other.

The diffusion layer may be formed to have a length less than 13 μl.

The first electrode material may be comprised of Ni or Ni alloy.

The second electrode material may be comprised of Cu or Cu alloy.

The diffusion layer may be comprised of Ni/Cu alloy.

The method may further include cutting the capacitor body to form respective units, between the compressing of the capacitor body and the firing of the capacitor body.

The number of laminated dielectric layers may be in a range of 50 to 1,000.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of a multilayer ceramic capacitor according to an embodiment of the present invention;

FIG. 2 is a cross-sectional view taken along line A-A′ of FIG. 1;

FIG. 3 is a cross-sectional view taken along line B-B′ of FIG. 1; and

FIGS. 4A to 4C are cross-sectional views illustrating a manufacturing process of a multilayer ceramic capacitor according to an embodiment of the present invention.

### DETAILED DESCRIPTION OF THE PREFERRED EMBODIMENT

Hereinafter, exemplary embodiments of the present invention will be described with reference to the accompanying drawings to fully explain the present invention in such a manner that it may easily be carried out by a person with ordinary skill in the art to which the present invention pertains. In the detailed description of exemplary embodiments of the present invention below, detailed descriptions related to well-known functions or configurations will be left out in order not to unnecessarily obscure subject matters of the present invention.

Throughout the drawings, like reference numerals denote like elements having the same construction and function.

In this disclosure below, when one part is referred to as being ‘connected’ to another part, it should be understood that the former can be ‘directly connected’ to the latter, or ‘electrically connected’ to the latter via an intervening part.

Furthermore, when it is described that one comprises (or includes or has) some elements, it should be understood that it may comprise (or include or has) only those elements, or it may comprise (or include or have) other elements as well as those elements if there is no specific limitation.

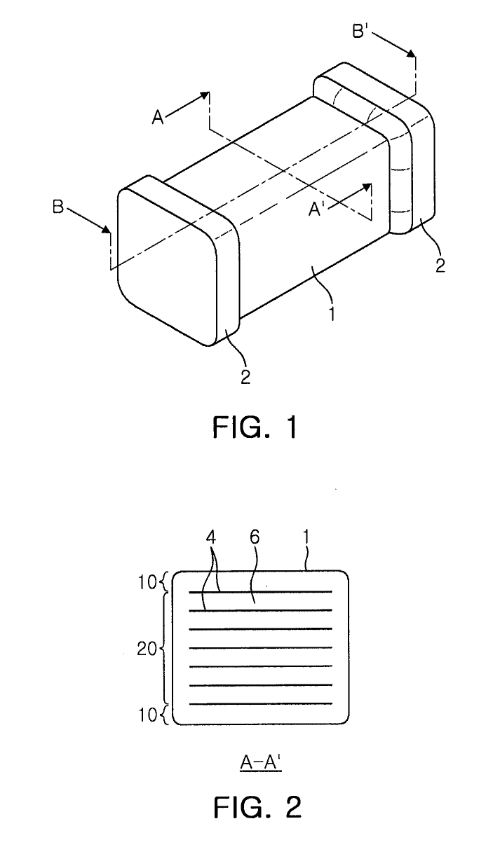

Herebelow, a multilayer ceramic capacitor and a manufacturing method thereof according to an embodiment of the present invention will be described with reference to FIGS. 1 to 4.

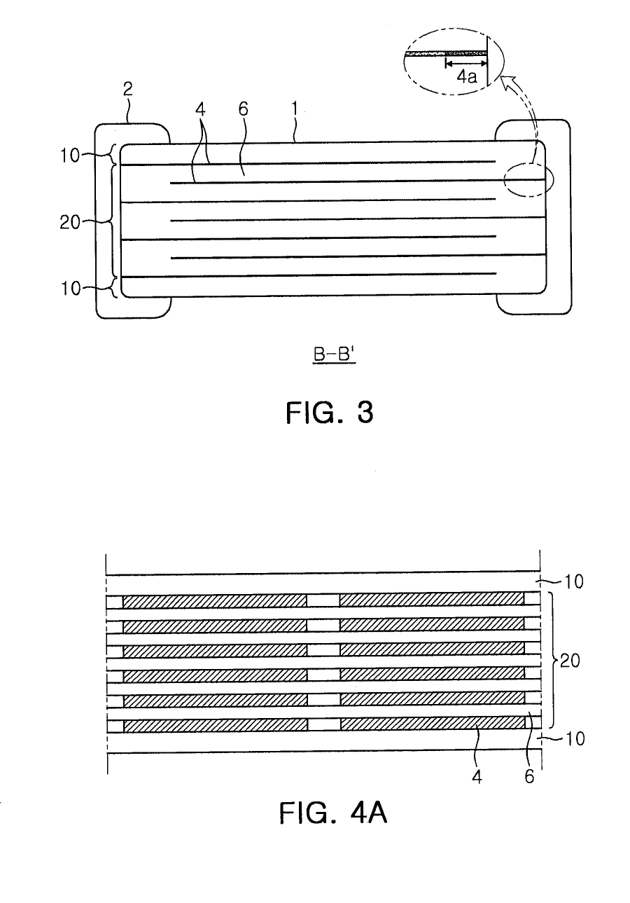

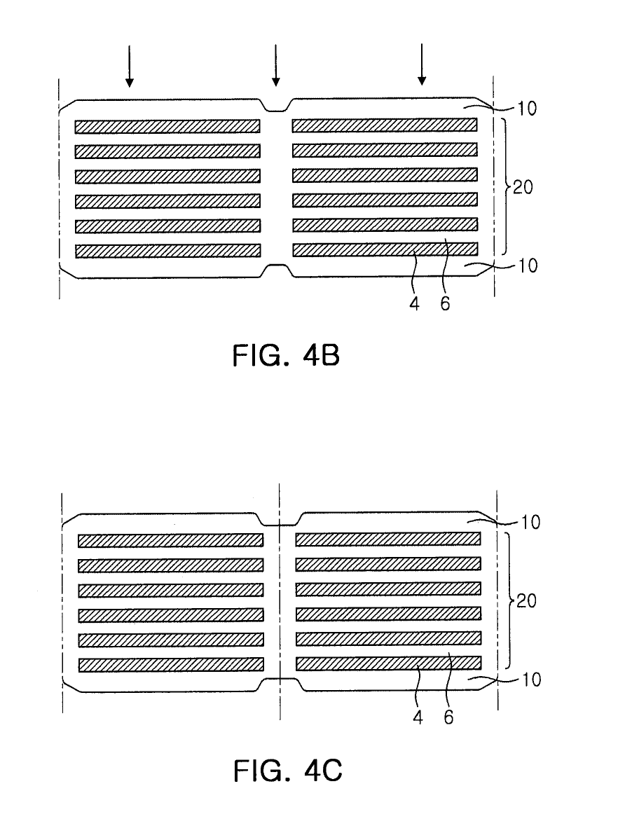

FIG. 1 is a perspective view schematically illustrating a multilayer ceramic capacitor according to an embodiment of the present invention, FIG. 2 is a cross-sectional view taken along line A-A′ of FIG. 1, FIG. 3 is a cross-sectional view taken along line B-B′ of FIG. 1, and FIGS. 4A to 4C are cross-sectional views schematically illustrating a manufacturing process of a multilayer ceramic capacitor according to an embodiment of the present invention.

A multilayer ceramic capacitor according to the embodiment of the present invention may include a capacitor body 1 and outer electrodes 2.

In the capacitor body 1, a plurality of dielectric layers 6 are laminated, and inner electrodes 4 are inserted between the dielectric layers 6. The dielectric layers 6 may be formed of barium titanate (Ba₂TiO₃).

The inner electrodes 4 may be formed of a first electrode material including nickel (Ni) or a Ni alloy. The outer electrodes 2, which are formed at both sides of an outer surface of the capacitor body 1 and electrically connected to the inner electrodes 4, are formed of a second electrode material including copper (Cu) or a Cu alloy. The outer electrodes 2 may serve as external terminals because they are formed to be electrically connected to the inner electrodes 4 exposed to the outer surface of the capacitor body 1.

Here, a diffusion layer 4a having a length exceeding 1 μm in which the first and second electrode materials are mixed is formed in a region where the inner electrode 4 and the outer electrode 2 are connected to each other. Also, the diffusion layer 4a is formed to have a length less than 13 μl. The diffusion layer 4a includes the second electrode material diffused from the outer electrode 2, and is thus comprised of Ni/Cu alloy.

The multilayer ceramic capacitor according to the embodiment of the present invention may include an effective layer 20 provided with the dielectric layers 6 and the inner electrodes 4 that are alternately laminated. Also, the multilayer ceramic capacitor may include a passivation layer 10 obtained by laminating dielectric layers on top and bottom surfaces of the effective layer 20.

Since the passivation layer is formed by sequentially laminating plural dielectric layers on the top and bottom surfaces of the effective layer 20, the effective layer 20 may be protected from external impacts or the like.

When the inner electrode 4 of the effective layer 20 is formed of Ni, the inner electrode 4 has a thermal expansion coefficient of about 13×10⁻⁶/, whereas the dielectric layer 6 formed of ceramic has a thermal expansion coefficient of about 8×10⁻⁶/. When a thermal shock is applied during a firing process and a mounting process of a circuit board by a reflow solder, a stress is exerted on the dielectric layer 6 due to a difference in thermal expansion coefficient between the dielectric layer 6 and the inner electrode 4. Accordingly, cracking may be generated in the dielectric layer 6 because of the stress caused by thermal shock.

Even when the diffusion occurs heavily from the outer electrode 2 toward the inner electrode 4, cracking may also be generated due to the expansion in the volume of the inner electrode 4. This causes a plating solution to penetrate into the generated cracks, leading to a decrease in product reliability.

Therefore, to not only stably secure capacitance but to also prevent the generation of cracking caused by the thermal shock and the expansion in the volume of the inner electrode 4, a manufacturing process is controlled in such a manner that the diffusion layer 4a obtained by the diffusion of the second electrode material into the inner electrode 4 should have a length greater than 1 μm but less than 13 μm after being fired, thereby improving the contact property between the inner electrode 4 and the outer electrode 2. Here, the diffusion layer 4a is formed on at least one of both ends of the inner electrode 4, and an appropriate length of the diffusion layer 4a of the inner electrode 4 may be determined through experimentations.

### EMBODIMENT

As illustrated in FIG. 4A, dielectric layers 6 of a capacitor body 1 were formed to include a binder, a plasticizer and a balance of dielectric material. Conductive inner electrodes 4 containing Ni were printed on the dielectric layers 6 obtained by molding a slurry having the above-described composition. Thereafter, a multilayer body with a predetermined thickness was made out of the printed dielectric layers 6. Here, number of the laminated dielectric layers 6 was in the range of 50 to 1,000.

Afterwards, as illustrated in FIG. 4B, the resultant is compressed at a predetermined temperature. Herein, it was exemplified that the multilayer ceramic capacitor had a W-section with a large cumulative stepped amount because empty spaces between the inner electrodes 4 printed in parallel and the dielectric layers 6 were alternately laminated. In an L-section of the multilayer ceramic capacitor, the dielectric layer 6 is also laminated in the empty space between the inner electrodes 4 printed in parallel like the W-section. However, the L-section of the multilayer ceramic capacitor differs from the W-section in that the empty space between the inner electrodes 4 is not positioned over the dielectric layer 6 but the inner electrode 4 is printed on the dielectric layer 6. Therefore, the W-section has a cumulative stepped amount that is relatively larger than that of the L-section, and thus the dielectric layer 6 between the inner electrodes 4 printed in parallel is further recessed during compression.

Thereafter, as illustrated in FIG. 4C, respective multilayer ceramic capacitors were formed by cutting the recessed portion of the multilayer ceramic capacitor.

Next, an outer electrode 2 containing Cu was attached and firing and plating processes were then performed, thereby completing the multilayer ceramic capacitor shown in FIG. 1.

TABLE 1

| | | | | | Number of | |
|---|---|---|---|---|---|---|
| | Depth of | Generated | | | Cracks | |
| | Diffusion | Number of | | | Generated | Reliability |
| | Layer | Diffusion | Capacitance | Capacitance | (Defects/ | (Defects/ |
| Embodiment | (μm) | Layers | (μF) | (Cpk) | Samples) | Samples) |
| 1 | 0 | 0 | 0.14 | −5.21 | 0/30 | 0/40 |
| 2 | 0.5 | 1-5 | 0.24 | −3.98 | 0/30 | 0/40 |
| 3 | 0.5 | 6-10 | 0.71 | 0.82 | 0/30 | 0/40 |
| 4 | 1 | 1-5 | 0.92 | 1.83 | 0/30 | 0/40 |
| 5 | 1 | 6-10 | 1.06 | 2.68 | 0/30 | 0/40 |
| 6 | 2 | 1-5 | 1.06 | 2.53 | 0/30 | 0/40 |
| 7 | 2 | 6-10 | 1.09 | 2.67 | 0/30 | 0/40 |
| 8 | 3 | 1-5 | 1.07 | 2.42 | 0/30 | 0/40 |
| 9 | 3 | 6-10 | 1.09 | 2.72 | 0/30 | 0/40 |
| 10 | 7 | 1-5 | 1.08 | 2.54 | 0/30 | 0/40 |
| 11 | 7 | 6-10 | 1.11 | 2.80 | 0/30 | 0/40 |
| 12 | 10 | 1-5 | 1.09 | 2.68 | 0/30 | 0/40 |
| 13 | 10 | 6-10 | 1.08 | 2.42 | 0/30 | 0/40 |
| 14 | 13 | 1-5 | 1.09 | 2.38 | 1/30 | 0/40 |
| 15 | 13 | 6-10 | 1.07 | 2.59 | 1/30 | 1/40 |
| 16 | 16 | 1-5 | 1.08 | 2.66 | 7/30 | 1/40 |
| 17 | 16 | 6-10 | 1.10 | 2.78 | 25/30 | 3/40 |

Table 1 shows test results for a capacitance of each multilayer ceramic capacitor, cracking caused by thermal shock and diffusion, and reliability according to a depth of the diffusion layer 4a of the inner electrode 4 in each of the multilayer ceramic capacitors that are prepared according to different firing conditions after coating an end of an outer surface of the capacitor body 1 with the second electrode material, e.g., copper paste.

From Table 1, even in case where the depth of the diffusion layer 4a is 1 μm or less, there is no problem in cracking and reliability that may be caused by the expansion in the volume of the inner electrode 4, however, there is a problem of a decrease in capacitance due to poor contact property. It can be understood that a capacitance is in a normal range but cracking is generated due to the expansion in the volume of the inner layer 4 if the depth of the diffusion layer 4 is 13 μm or more. Furthermore, it can be understood that a capacitance is in a normal range but number of cracks and reliability problems caused by the expansion in the volume of the inner layer 4 are significantly increased if the depth of the diffusion layer 4 is 16 μm or more. According to these results, it can be seen that it is possible to realize a multilayer ceramic supercapacitor with large number of laminated layers by controlling the diffusion layer 4a of the inner electrode 4 to have a depth greater than 1 μm but smaller than 13 μm.

As set forth above, according to exemplary embodiments of the invention, it is possible to provide a multilayer ceramic capacitor and a manufacturing method thereof, which cannot only stably secure capacitance but also prevent cracking caused by the diffusion of an electrode material.

Also, a crack and delamination due to the diffusion from an outer electrode to an inner electrode can be prevented by improving the contact property at an interface between the inner electrode and the outer electrode.

In addition, by establishing relations among a capacitance, the generation of cracks and a reliability problem according to the depth of the diffusion layer from the outer electrode to the inner electrode and the reliability of the multilayer ceramic supercapacitor having large number of laminated layers can be enhanced through appropriately controlling of the depth of the diffusion layer.

While the present invention has been shown and described in connection with the exemplary embodiments, it will be apparent to those skilled in the art that modifications and variations can be made without departing from the spirit and scope of the invention as defined by the appended claims.

What is claimed is:

1. A multilayer ceramic capacitor comprising:
a capacitor body where an inner electrode including a first electrode material and a dielectric layer are alternately laminated; and
an outer electrode disposed on an outer surface of the capacitor body and electrically connected to the inner electrode, the outer electrode including a second electrode material,
wherein a diffusion layer having a length exceeding 1 μm in which the first and second electrode materials are mixed is provided at a region where the inner electrode and the outer electrode are connected to each other.

2. The multilayer ceramic capacitor of claim 1, wherein the diffusion layer has a length less than 13 μm.

3. The multilayer ceramic capacitor of claim 1, wherein the first electrode material comprises nickel (Ni) or Ni alloy.

4. The multilayer ceramic capacitor of claim 1, wherein the second electrode material comprises copper (Cu) or Cu alloy.

5. The multilayer ceramic capacitor of claim 1, wherein the diffusion layer comprises Ni/Cu alloy.

6. The multilayer ceramic capacitor of claim 1, wherein the number of laminated dielectric layers is in a range of 50 to 1,000.

7. A method of manufacturing a multilayer ceramic capacitor, the method comprising:
forming a capacitor body by laminating an inner electrode including a first electrode material and a dielectric layer alternately;
forming an outer electrode electrically connected to the inner electrode on an outer surface of the capacitor body, the outer electrode including a second electrode material;
forming a passivation layer including a dielectric forming material on at least one of top and bottom surfaces of the capacitor body;
compressing the capacitor body; and
firing the capacitor body,
wherein a diffusion layer having a length exceeding 1 μm in which the first and second electrode materials are mixed is formed at a region where the inner electrode and the outer electrode are connected to each other.

8. The method of claim 7, wherein the diffusion layer is formed to have a length less than 13 μm.

9. The method of claim 7, wherein the first electrode material is comprised of Ni or Ni alloy.

10. The method of claim 7, wherein the second electrode material is comprised of Cu or Cu alloy.

11. The method of claim 7, wherein the diffusion layer is comprised of Ni/Cu alloy.

12. The method of claim 7, further comprising cutting the capacitor body to form respective units, between the compressing of the capacitor body and the firing of the capacitor body.

13. The method of claim 7, wherein the number of laminated dielectric layers is in a range of 50 to 1,000.
